(19) United States
(12) Patent Application Publication
(10) Pub. No.: US 2019/0270358 A1
(43) Pub. Date: Sep. 5, 2019

(54) MOTORCYCLE SUSPENSION SYSTEM WITH INTEGRATED RIDE HEIGHT SENSOR

(71) Applicant: THUNDER HEART PERFORMANCE CORP., White House, TN (US)

(72) Inventors: Jerold M. Korrect, Cottontown, TN (US); Shane Scott, Hendersonville, TN (US); Daniel J. Korrect, White House, TN (US)

(21) Appl. No.: 16/293,491

(22) Filed: Mar. 5, 2019

Related U.S. Application Data
(60) Provisional application No. 62/638,880, filed on Mar. 5, 2018.

(51) Int. Cl. B60G 17/018; B62K 25/04; B60G 3/01; B60G 17/015

(52) U.S. Cl. CPC B60G 17/018; B62K 25/04; B60G 3/01; B60G 17/0155; B60G 2600/187; B62K 2025/045; B60G 2300/12; B60G 2400/10; B60G 2400/252; B62K 2201/08

(57) ABSTRACT

A vehicle suspension system is described. The suspension system comprises a first and second suspension dampening component, the second suspension component comprising an air spring. A compact Electronic Suspension Control System is included, and utilizes an integrated ride height sensor system, including a sensor and ride height arm coupled is to the ride height sensor, an air management manifold and solenoids, and a plurality of pneumatic inputs and outputs coupled to the air management manifold, in order to control the pneumatic conditions of the air spring. The system also includes a pneumatic pump and processor for activating the solenoids and pump in response to sensed conditions, or users inputs, in order to dynamically change suspension settings.

### PRIORITY CLAIM

This application is a nonprovisional of U.S. Provisional Application No. 62/638,880 filed on Mar. 5, 2018; which application is hereby incorporated by reference in its entirety as if fully set forth herein.

### COPYRIGHT NOTICE

This disclosure is protected under United States and International Copyright Laws. © 2019 Thunder Heart Performance Corp. All rights reserved. A portion of the disclosure of this patent document contains material which is subject to copyright protection. The copyright owner has no objection to the facsimile reproduction by anyone of either the patent document or the patent disclosure, as it appears in the Patent and Trademark Office patent file or records, but otherwise reserves all copyrights whatsoever.

### FIELD OF THE INVENTION

This invention relates generally to suspension systems and, more specifically, to suspension systems for motorcycles.

### BACKGROUND OF THE INVENTION

The design consideration of any vehicle's suspension system is very important in relationship to the vehicle's overall handling and stability. Moreover, the design of the suspension system on a lightweight vehicle such as a motorcycle is even more critical considering the relative weight of the vehicle compared to the weight of the rider(s) and luggage. For example, a typical “touring model” motorcycle weighs approximately 650-900 lbs. whereas the average rider weight, plus potential passenger and luggage could attain a total vehicle weight of approximately ˜1500 lbs.

Therefore, considering this relatively large range of sprung weight on the motorcycle's rear wheel (encompassing approximately ˜60% of total weight distribution), there is often a design compromise realized in the prior approaches between ride comfort due to suspension travel, suspension dampening including compression, rebound characteristics and static vehicle height (stance).

Prior art suspension systems fail to meet all of the challenges posed by large changes in sprung weight. The most common suspension system is a coil-spring over shock absorber design (commonly called a “coil-over”) which is an oil filled shock with a fixed nitrogen gas charge that utilizes an external spring to assist with damping. A coil-over shock can be designed as “non-adjustable” in which the spring preload is fixed, or as “adjustable” in which the spring preload can be manually modified via a moveable spring perch. Some models use a preload adjustment knob for accomplishing this movement and/or the shock dampening may be adjustable. This is a commonly used design on original equipment (“O. E.”) Harley Davidson Touring Models, as well as many other types of motorcycles, touring or otherwise.

Suspension systems utilizing traditional coil-over shock absorbers are the most commonly used design for motorcycles; however, they require manual adjustment of spring pre-load (if an option) in order accommodate various vehicle rider configurations and load conditions (though this adjustment is not very precise). In order to achieve a desired vehicle height, the coil-over shock absorber set will often be replaced with another shorter set which will have less shock travel, and therefore less overall dampening, and can result in a diminished ride comfort.

Another prior art suspension system is an air-adjustable shock absorber design. The air-adjustable shock absorber is an oil-filled shock with an air charge that can be adjusted to allow for manual suspension “tuning” by use of a manual air pump based on vehicle load. This was a design on O. E. Harley Davidson Touring Models. Suspension systems utilizing air-adjustable shock absorbers face similar disadvantages (i.e. manual adjustment), found in the coil-over design.

Yet another type of suspension system is an air-spring (air bladder) shock absorber design, which is an oil-filled shock with a fixed nitrogen gas charge that utilizes an external air bag to assist with damping. To achieve a desired “spring rate” (i.e. air pressure) the air bag can be inflated or deflated by means of a vehicle mounted air compressor and a pneumatic distribution system (i.e. hoses, fittings, manifold blocks) which are manually operated by electric switches. This system is utilized primarily as an aftermarket suspension upgrade.

Suspension systems utilizing “air-spring” shock absorbers as noted are typically utilized in aftermarket motorcycle applications. The reason these systems are not commonly seen in O. E. applications is likely poor reliability—if the air bladder should rupture, the compressor may fail, and/or the system may develop an air leak (fittings, hoses, etc.). The suspension system has little or no dampening, and therefore a ruptured air bladder can result in a vehicle which cannot be safely driven and/or a possible stranded rider. These systems do allow vehicle height adjustments via electronic switches controlling solenoids for pneumatically porting the air-bladder; however, this is still a manual adjustment without system feedback.

Air springs also may require excessive spring rate with insufficient bump and rebound characteristics, such that hard bumps (uneven road surface) can cause the rear wheel to become airborne. In extreme cases, this can lead to loss of control of the vehicle. An additional focus of the present invention is on increasing safety, and preventing these types of unsafe situations.

Additionally, there are other air-spring (air bladder) suspension systems commonly seen in aftermarket automotive applications (4+ wheel vehicles). These systems utilize multiple air-spring shock absorbers, a central engine control module (“ECM”), manifold systems with solenoids, remote vehicle ride height sensors (typically on all wheels or corners of the vehicle), a compressor with an air tank reservoir, and associated wiring and pneumatic plumbing. This system utilizes a user interface control (i.e. remote control) which can adjust vehicle height settings on all wheels independently and monitor system pressure. This system however faces similar reliability concerns as the motorcycle system. These systems do not make adjustments for vehicle speed, throttle position, and/or braking conditions. Further, due to the physical size, use of remote vehicle ride height sensors, and utilization of an auxiliary air tank reservoir, this automotive system cannot be easily adapted to a motorcycle application.

### SUMMARY OF THE INVENTION

This invention was developed to address the long-standing issues with motorcycle suspension systems, including those mentioned above, especially for “touring models,” due to the significant load variance (i.e. additional riders and/or luggage—which also shifts vehicle center of gravity considerably) and associated design tradeoffs which result in a compromised quality of ride, vehicle stability and safety.

O. E. suspension systems on most motorcycle models are considerably lacking in ride comfort and in the ability to be easily adjusted and properly “tuned” to better suit the use case. This is especially true where the use case may change day to day, ride to ride, or even during a ride.

The current process for adjustment is unnecessarily time consuming since the motorcycle has to be partially disassembled, for example, saddlebags removed for access, and requires manual adjustment of the shock absorbers and spring pre-load. This procedure is not precise since all weights (loads) should be known in order to properly make adjustments. This would require knowing the weight of the passenger(s), and their luggage, for example. Further, many consumers lack the knowledge or are not interested in attempting to adjust their own suspension components.

Embodiments of the present invention provide a motorcycle suspension system which can quickly, easily, and more accurately adjust suspension characteristics automatically in order to help all riders i.e. men, women, children etc., with all build statures i.e. weight, height, etc., and riding styles i.e. additional passenger and/or luggage, feel comfortable when they ride.

An embodiment of the invention consists of a combination of controlled devices (i.e. system) for achieving desired vehicle ride height and suspension characteristics.

An embodiment of the present invention comprises a suspension system that provides a compact, electronically controlled air-assisted suspension system for motorcycle applications.

According to various embodiments, the suspension system may combine a coil over style shock absorber and an air spring cylinder. The air spring cylinder may be controlled by an onboard electronic suspension control module (ESCM). The ESCM is preferably compact, and includes at least one processor, and a number of sensors, including, for example, pressure, accelerometers, ride height sensors, and the like. In a preferred embodiment, the ride height sensor is built into the ESCM, and a ride height arm, or tie rod, extends therefrom to the air spring cylinder such that extension or retraction of the air spring is transferred, via the ride height arm, to the ESCM, where the movement is sensed by the ride height position sensor. The ESCM also, preferably, houses an air management system, also coupled to the processor, and including an air manifold in pneumatic communication with the air spring, and a pneumatic compressor or pump. Processor control of the air manifold allows fine tuning and adjustment of the air spring, via the air manifold and pneumatic connections to the air spring.

In accordance with some examples of the invention, the suspension system can actively monitor, using onboard sensors, and intelligently adjust for vehicle conditions and various rider configurations (i.e. weight, height, additional riders, luggage, road conditions, weather, sportiness, rider preferences, etc.).

In accordance with some examples of the invention, the suspension system includes integrated sensor feedback. According to this exemplary embodiment, the system may pneumatically adjust vehicle ride height, for example via an air spring cylinder, in order to attain optimal suspension travel levels. Optimal suspension travel levels may be based on, for example, dynamic vehicle conditions including vehicle speed, engine speed, throttle position, lean angle, braking, road conditions, weather, temperature, shock pressure, etc. By way of example, the target ride height may be X. A rider gets on his or her motorcycle with a passenger and two full saddle bags. As a result, the vehicle is weighed down such that the ride height is now less than X, in other words, the vehicle is closer to the ground than would be optimal. Sensing this, the processor can instruct the system to raise the vehicle, via the air spring, by increasing the air spring pressure. Continuing this example, if the driver dropped the passenger off at his or her destination, now the vehicle would be at a hide height of more than X, or higher than optimal. Sensing this, the system can exhaust pressure from the air spring, lowering the vehicle to its optimal ride height.

In accordance with some examples of the invention, key suspension system characteristics including spring rate, and dampening (i.e. compression/rebound) may be adjustable, for example via a “coil-over” shock absorber, which provides a complete suspension system designed to achieve improved rider comfort, vehicle stability, and overall vehicle performance.

In accordance with some examples of the invention, the system may form an integrated system, including a ride height sensor system, as well as other sensors, which when combined, reference sensor values to adjust suspension settings dynamically.

For example, according to the previous example, vehicle speed may be referenced by the suspension system via the on-board engine control unit (“ECU”) and controller area network (“CAN”) bus connection to the suspension system. When the motorcycle comes to a stop, the suspension system may automatically lower the motorcycle to assist the rider in making contact with the ground.

In accordance with various examples of the invention, ride height is determined by an integrated ride height sensor. This integrated sensor provides for better packaging, increased reliability, and direct referencing of the vehicle's ride height.

These and other examples of the invention will be described in further detail below.

### BRIEF DESCRIPTION OF THE DRAWINGS

Preferred and alternative examples of the present invention are described in detail below with reference to the following drawings. Additional copies of the drawings or figures are supplied herewith:

FIG. 1A is a deconstructed view of a motorcycle exhibiting one possible embodiment of the present invention.

FIG. 1B is a deconstructed view of a motorcycle exhibiting one possible embodiment of the present invention.

FIG. 2 is a transparent view of the rear of a motorcycle exhibiting one possible embodiment of the present invention.

FIG. 3 is a system view of the various components of an embodiment of the present invention, and their connections, according to one possible embodiment of the present invention.

FIG. 4A is a view of a printed circuit board (“PCB”) and subcomponents thereon according to one possible embodiment of the present invention.

FIG. 4B is a view of a PCB and subcomponents thereon according to one possible embodiment of the present invention.

FIG. 5A is an ESCM with corresponding and integrated features and components according to one possible embodiment of the present invention.

FIG. 5B provides an additional transparent view of an ESCM and corresponding and integrated features and components according to one possible embodiment of the present invention.

FIG. 5C is an exploded view of an ESCM and corresponding and integrated features and components according to one possible embodiment of the present invention.

FIG. 6 is an example of mounting the user interface display according to one possible embodiment of the present invention.

### DETAILED DESCRIPTION OF THE INVENTION

Referring now to the drawings, wherein like reference numbers are used herein to designate like or similar elements throughout the various views, illustrative embodiments of the present invention are show and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

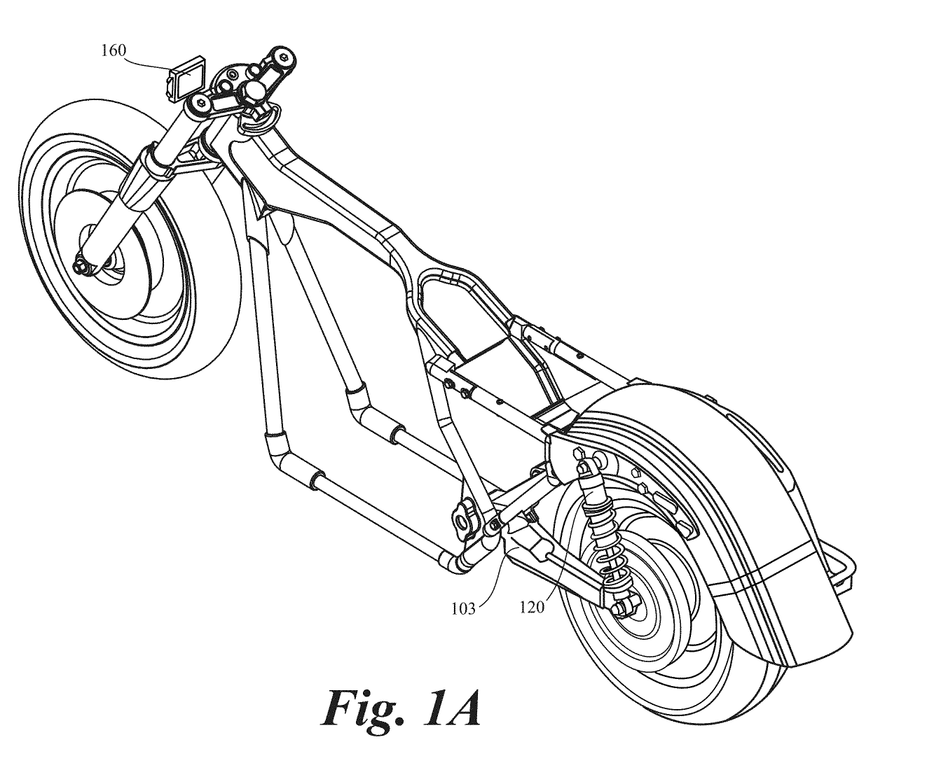

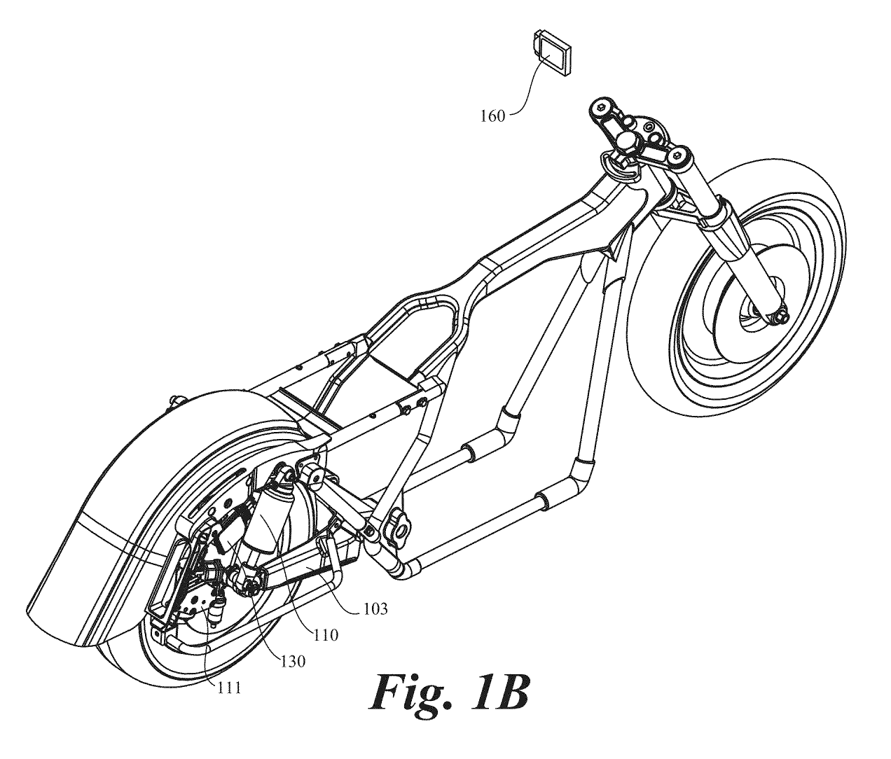

FIGS. 1A and 1B each depict a side of the vehicle, together forming a more complete view, of an embodiment of the present invention. As shown, the present invention provides a compact, electronically controlled air-assisted suspension system for motorcycle applications. According to the depicted embodiment, the suspension system may be located at or near the rear wheel of the motorcycle. The system includes a plurality of different components and sub-components, but is neatly packaged as required. The depicted embodiment uses two different types of dampening devices.

Referring to FIG. 1A, the depicted suspension system employs, at one side of the vehicle, a traditional coil-over suspension system 120 with the shock attached to the motorcycle swing arm 103 at one end, and the frame at the other.

Referring to FIG. 1B, the depicted suspension system employs, at a second side of the vehicle, an air spring 110 connected to the vehicle and the swing arm 103. The air spring is in pneumatic communication with a compressor 111 and the ESCM 130.

The ESCM 130 may be mounted to the rear frame/fender strut of a motorcycle. According to the depicted embodiment, the ESCM 130 is strategically located above the rear tire proximate to the rider's seat for improved dynamic monitoring. It should be understood that the mounting location of the ESCM 130 will differ depending on the particular model and type of vehicle it is being attached to. However, general proximity to the suspension components, for example allowing the integration of a ride height sensor and sensor arm connected to a reference point on the suspension, may be preferred. The reference point is preferably a point on the suspension that moves with the sprung mass. The system depicted in FIGS. 1A and 1B can actively monitor and intelligently adjust for vehicle conditions and various rider configurations such as, for example, but not limited to, weight, height, additional riders, luggage, road conditions, ride preferences, responsiveness selections, weather, etc. In many embodiments, these adjustments can be made automatically, or manually by using user interface 160.

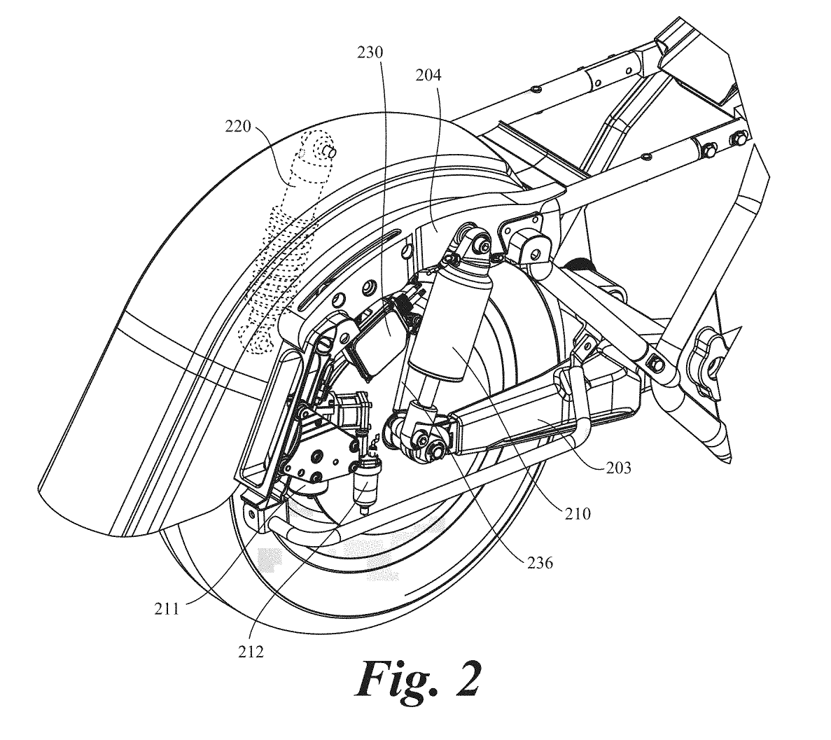

FIG. 2 provides a view of an embodiment of the present invention. The combination of an air spring cylinder 210 and a coil-over shock absorber 220 is depicted. Either is connected to the swing arm 203 at one end, and the frame 204 at the other. The combination of an air spring 210 and coil-over shock 220 can provide a rear wheel suspension system with a progressive spring rate. The coil-over shock absorber 220 has been developed with specific valving for compression and rebound characteristics with a matched coil spring that works in conjunction with the air spring cylinder 210. The invention may also consist of a single air spring cylinder 210, a single coil-over shock 220, a vehicle mounted air compressor 211 with dryer and filter assembly 212, associated pneumatic plumbing and wiring interconnects, and an ESCM 230 with integrated pneumatic valving and ride height sensor.

In some embodiments, the shock absorber in coil-over 220 or air spring 210 may be adjustable, either manually or electronically. This combination provides an improved comfort of ride while also providing improved reliability over typical suspension systems utilizing air spring shock absorbers and air spring cylinders. For example, improved reliability may be achieved through a designed “limp mode.” According to this example, the coil-over shock absorber 210 design specification may be able to handle moderate vehicle loads should any pneumatic system and/or electronic components fail (i.e. compressor, fittings and hoses, solenoids, seals, wiring, etc.).

According to various embodiments, including as depicted, a ride height sensor may be integrated into an ESCM 230. This may also include an arm 236 attached to suspension components 203 in order to deliver feedback to the ESCM 230 regarding suspension characteristics and positions. In alternative embodiments, different methods of hide-height sensing may be used, for example, optical sensors may exist in the ESCM 230 or elsewhere.

As depicted, the system may also include an air compressor 211. The ESCM 230 can control delivery of compressed air, as well as exhausting of air, to and from the air spring cylinder 210 as necessary. The air compressor 211 may deliver air to the ESCM 230 on demand, where a manifold may be electronically controlled in order to facilitate the necessary transfer of the compressed air to components of the suspension system based on various inputs to the ESCM 230. Various hoses or tubing of sufficient capacity and strength may be used to facilitate the movement of air throughout the system. In alternative embodiments, the air compressor 211 may be joined by an air tank, not shown, which may be disposed between the compressor 211 and the ESCM 230, for example. In such an embodiment, the air tank may maintain an elevated pressure, such that the air spring cylinder 210 may be filled by the air tank. The depicted arrangement is not to be limiting. The location of the components may change, for example, the air compressor may be mounded horizontally near the base of the air spring, or in any other configuration. In other embodiments two shocks of the same type may be used, or, alternatively, may be combined into a single shock, where a uni-shock setup is required. In further examples, more than two shocks may be used, for example, a smaller helper shock could be mounted to the swing arm or elsewhere.

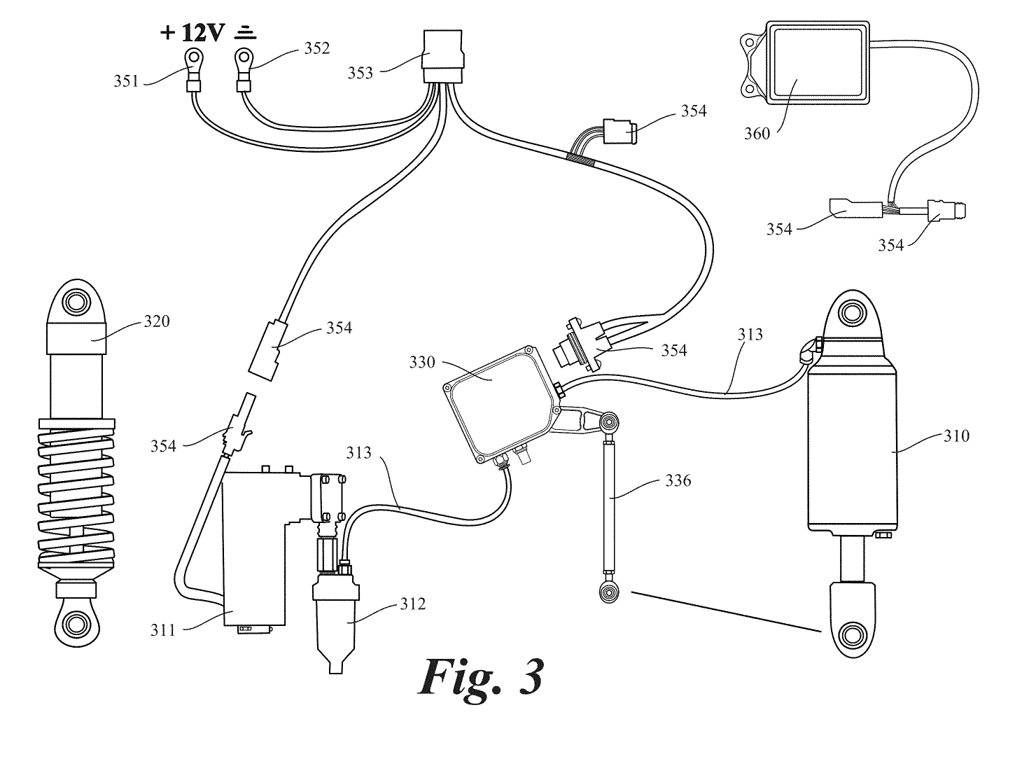

FIG. 3 depicts an embodiment of the various components and subcomponents of a complete system, for example as depicted and referred to in FIGS. 1A, 1B, and 2. As depicted, the integration between components and subcomponents, which together form an embodiment of a complete system of the present invention, is discernable. A coil-over style shock 320 and an air spring 310 are shown. Air spring 310 is pneumatically connected, via a line or hose 313 of sufficient strength, to the ESCM 330. Air spring 310 is also connected to one end of the ride height rod 336. The opposing end of ride height rod 336 is connected to the ride height sensor integrated into ESCM 330. ESCM 330 is also pneumatically connected by line 313 to the air compressor 311 and dryer 312 arrangement. The compressor 311 and dryer 312 provide system pressure, as controlled and directed by the ESCM 330. The electronic connections 354 which connect the various subcomponents of the overall system are shown. These connections provide power 351 and ground 352, but also provide for the transfer of vehicle data over a communication network such as CAN. For example, user display 360 is in electronic communication, via connections 354, with ESCM 330, such that the user's selections are communicated to the ESCM 330 and carried out. For example, the user could select an increased ride height. The user's selection on user display 360 is sent, via connections 354 to the ESCM 330. ESCM 330 registers the request, and sends a corresponding signal, via connection 354, to the air compressor 311, activating the air compressor and opening the pneumatic connection over line 313 to the air spring 310, increasing the pressure and extending air spring 310. This extension is monitored by the motion of the ride height rod 336, until the ride height sensor in ESCM 330 senses the desired height, at which point the compressor 311 is switched off and the valving closed.

The components of the system as described according to various embodiments of the present invention are in communication with each other, and powered through use of a wiring harness. The various components may all be connected to one, or multiple sub-harnesses depending on the needs of the system. For example, in various embodiments, the harness may allow integration of the headlights, such that, as the vehicle ride-height changes, so does the angle of the headlight. This could be accomplished through appropriate integration of the headlight systems into the wiring harness. Of course, other arrangements, configurations, and component types than those shown in FIG. 3 are possible and envisioned.

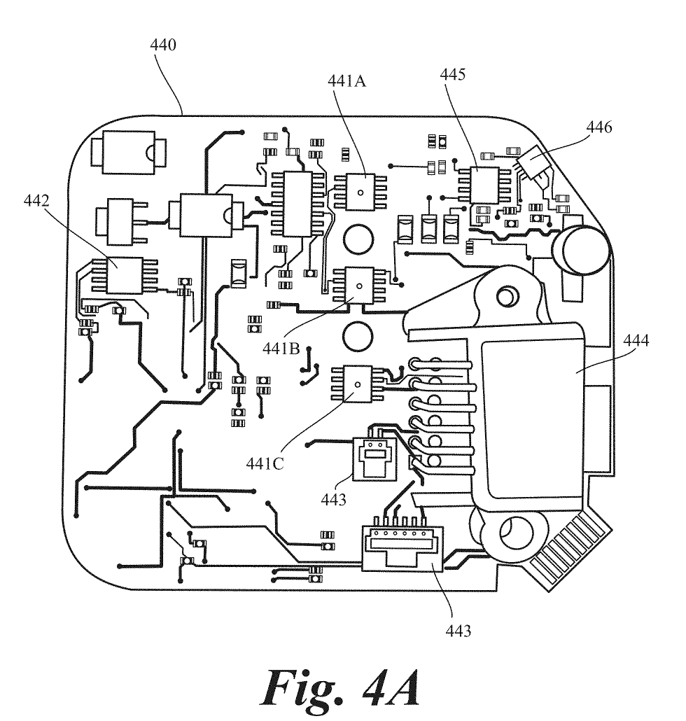

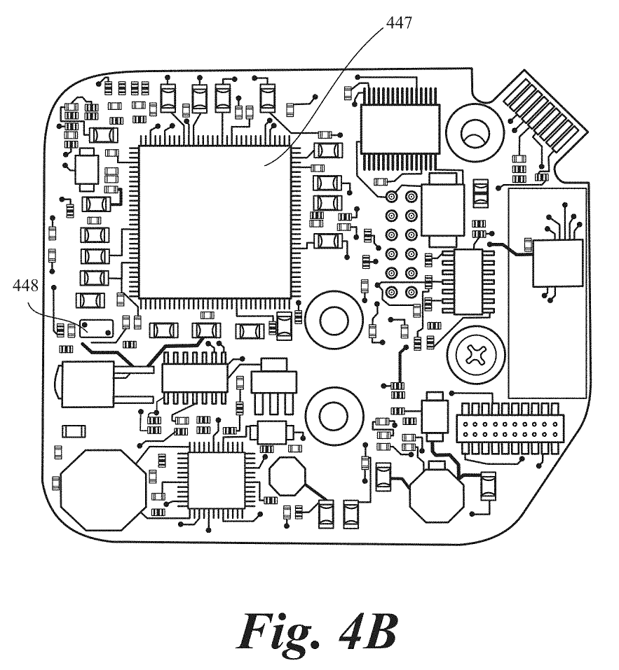

FIGS. 4A and 4B depict an example of a PCB 440. PCB 440 is optionally found within the ESCM 330, according to various embodiments of the present invention. PCB 440 includes a number of subcomponents, all of which work together in order to provide increased functionality to the overall system. PCB 440 may include, for example, integrated circuit rotary/linear position IC 446 for monitoring vehicle ride height, combined multi-axis accelerometer and magnetometer IC 445 for monitoring transient acceleration conditions and vehicle orientation, and barometric pressure sensor 448. PCB 440 may also include a number of other sensors, 441A-C such as pressure transducer IC(s) for monitoring system air pressure(s), temperature sensors for monitoring outside temperature, compressor pressure and temperature or the like. PCB 440 also includes an interconnect port 444 which allows the PCB 440 and all the subcomponents thereon, to be in bidirectional communication with any of the components of the vehicle. For example, referring back to FIG. 3, interconnect 354 connects to port 444 to provide communication from and between the ESCM and all of the other various components of the described suspension system, and additionally components of the vehicle such as an on board computer, traction control system, and any sensors the vehicle may have (speed, rpm, etc.). PCB 440 also preferable includes one or more solenoid interconnects 443. These connections provide for bidirectional communication between the subcomponents on the PCB 440 and the one or more solenoids controlling air flow throughout the system.

The PCB 440 may also include means for storing information 442, such as flash memory or any other short or long term memory module known in the art. In various embodiments, the storage means 442 may allow for setups, or “tunes” to be saved and recalled. For example, a customer may prefer a specific pre-set of suspension characteristics, i.e. ride height, shock absorber valving, and spring-rate, this setup may be stored on sub-components 442 of the PCB 440 for retrieval.

The PCB 440 may also include processing power, for example, a microprocessor 447. The processing power may be used for various functionalities. For example, a processor may execute code which compares various sensor inputs with target values, and responds by outputting information to facilitate adjusting suspension characteristics based on the values. PCB 440 can accept input via port 444, process that request via processor 447 and if necessary, with reference to information stored in memory module 442, or any sensor values from onboard sensors 441A-C (understanding that more than 3 sensors are possible, including 441N sensors), 445, 446, 448, and output an instruction to any connect component, such as a solenoid, or the air compressor.

The PCB 440 is not limited to the depicted arrangement. Additional sub-components may be included on the board, for example: microcontrollers, GPUs, and other sensors, and components are possible. Additional sensors 441A-C(N), or components providing increased and additional functionalities may be added. For example, a temperature sensor, GPS, or optical sensor, may be included.

The PCB 440 may also accept various additional inputs from remote mounted sensors via port 444, which it may communicate with through various interconnects. In additional examples, the PCB 440 may include a wireless transceiver to facilitate wireless communication with various components. Alternatively, or in addition, a Bluetooth® transceiver may be added. Wireless capabilities may be used, for example, to communicate with the system components, or with User devices, a Smart Phone, for example, or other diagnostic equipment.

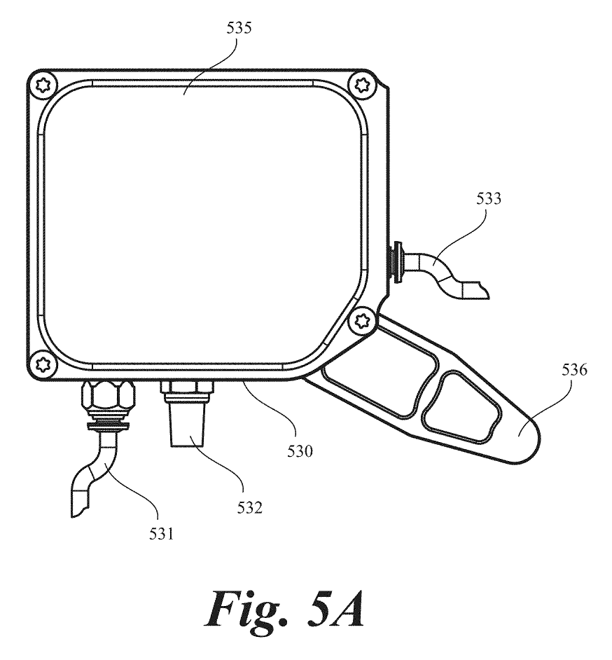

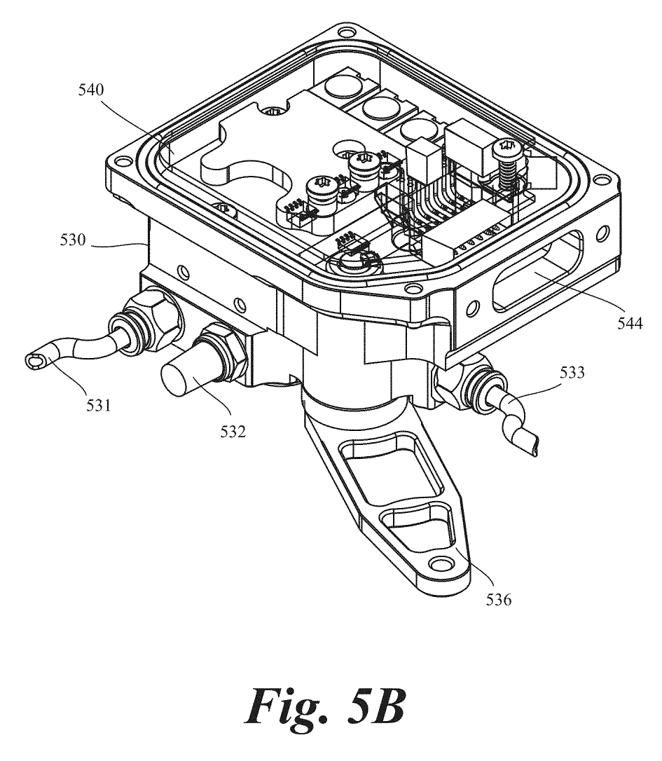

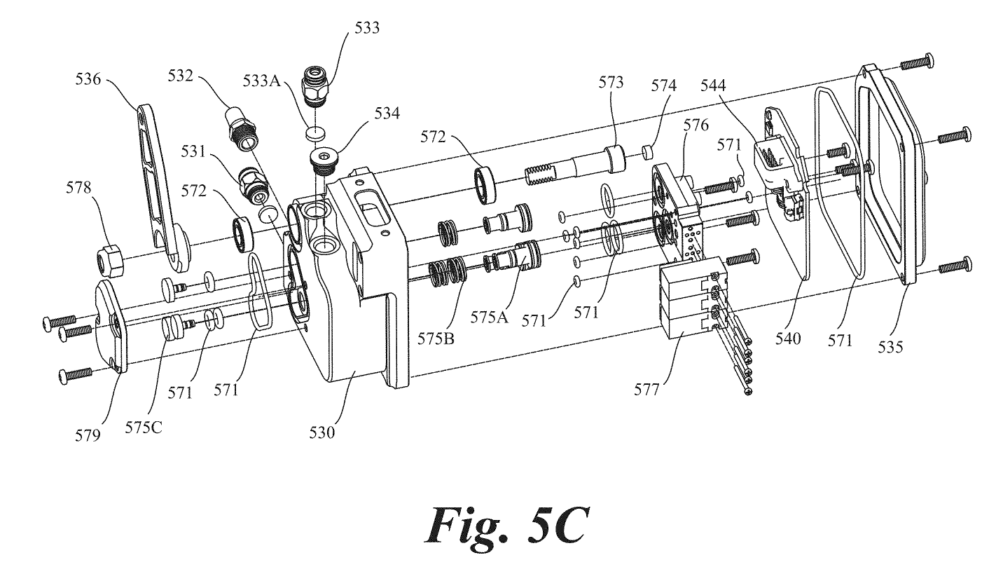

FIG. 5A depicts an embodiment of the ESCM's 530 housing. According to various embodiments, the ESCM 530 housing may contain associated pneumatic porting. For example, the housing may include an inlet port 531, one or more bi-directional service ports 533, and one or more exhaust port(s) 532. In various embodiments, the inlet port 531 may connect the ESCM 530 to the air compressor, or an air tank. The service port(s) 533 may connect the ESCM 530 to the air springs associated with the front and rear suspension. The exhaust port(s) 532 may allow pressurized air from the air-spring(s) to discharge to the atmosphere. Each of the inlet 531, service 533, or outlet valves 532 corresponds to a portion of an air manifold and solenoid mounted inside ESCM 530, as described further, below. Various other arrangements of the inlet 531, service 533, or outlet valves 532, are possible, and the above description is not limiting.

Ride height arm 536 is also shown. Ride height arm 536 preferably connects, via a rod or any other type of linkage, to the suspension of the motorcycle. The connection can be accomplished in any number of ways, for example, a hole at the end of ride height arm 536 may be used to locate and removably attach the linkage. Connected in this way, suspension movement is transmitted to ride height arm 536, the movement of which is sensed, for example, referring back to FIG. 4A, by an integrated rotary/linear position IC 446.

FIG. 5B depict an embodiment of the ESCM 530 with the top removed, revealing its interior, including, for example the PCB 540, and pneumatic components i.e manifold and poppets. Additional cross sections depict the hosing inlet 531 and service ports 533 to the air poppets, and also depict the porting to and from the air manifold to sub-miniature solenoid(s). The ESCM 530, according to various embodiments of the present invention, includes a service port 533, integrated into the ESCM housing 530. In additional examples, the inlets 531, service port 533, and exhaust 532 fittings may be removable, for example, to change fitting sizes, or to replace them should they become damaged. The ESCM 530 includes in inlet port 531, which may lead to an air poppet. An air manifold may also be included. The air manifold allows for the control of the air as it traverses the system. The system may be programmable as to control the air manifold and air management. The air manifold, air-poppets, solenoids, as well as the inlet, service, and exhaust ports, may share space within the ESCM 530 housing with the PCB 540, and integrated ride sensor system including ride height arm 536, bearings 572, axel 573, and magnet 574. The ESCM 530 may also include interconnect portions 544, to allow input and output of information from the ESCM 530 to other components of the system, and the vehicle. By way of non-limiting example, the ESCM 530 may be connected to a display, the air compressor, sensors on the dampening devices, and the vehicle CAN system as a sub-system.

The ESCM, as depicted, includes an interconnect port. This port allows for the ESCM module, and its subcomponents, to bi-directionally communicate with other parts of the suspension system, and the vehicle. The connections from the interconnect port are shown as connecting to the PCB. For example, according to various embodiments of the present invention, the interconnect port may allow for a CAN bus cable to be connected. The interconnect may also provide power, or there may be a second or other power connection. While FIG. 5B depicts a single interconnect, multiple may be used to accommodate different designs and sensor packages as needed.

In embodiments using CAN bus, a CAN bus cable may allow for the transfer of data throughout the vehicle. Where CAN bus is used, the ESCM 530 may bi-directionally communicate with the vehicle's existing CAN bus system. For example, the ESCM 530, via the CAN bus, may be able to reference vehicle data. This allows for the suspension system to monitor dynamic vehicle conditions (i.e. vehicle speed, engine speed, throttle position, braking) and can make adjustments based on vehicle feedback such as lowering suspension of the vehicle when stopped (safe level of seat height is important for shorter riders) and adjusting the suspension's characteristics at various vehicle cruising speeds. The functionalities are not limited to those discussed here. The system may be capable of producing nearly limitless results in response to a myriad of sensed conditions. These responses may be user programmable, and or dynamic.

Additional embodiments may communicate using a different protocol, or through individual electrical connections and traditional electrical signals and senders.

FIG. 5C depicts an exploded view of the embodiment shown in FIGS. 5A and 5B. The ESCM 530 includes various subcomponents. For example, according to various embodiments of the present invention, the ESCM 530 may include an air manifold 576, air solenoids 577, PCB 540, and poppets, poppet springs and poppet retainers, 575A-C respectively. The various inlet, outlet, and exhaust ports, 531-533 are shown as well as a bung 534 that may be used to plug unused ports in ESCM 530 and filters 533A. Various seals 571 are also shown to prevent air from leaking out of the system.

In many embodiments, control is facilitated by poppets 575A, solenoids 577, and or an air manifold 576. Further, embodiments of the present invention may utilizes an integrated air manifold system with sub-miniature solenoids mounted to the manifold and connect to pressure transducer IC's on the PCB (see FIGS. 4A and 4B). The connection to transducers on the PCB may allow for direct control over the solenoids to precisely control airflow throughout the system. Other embodiments may use other means of controlling airflow in and out of the manifold, such as other types of electronically operated valves.

According to various embodiments of the present invention, information may be transmitted to the PCB 540, including to any of the components thereon (see FIGS. 4A and 4B), via port 544. PCB 540 is electronically connected to solenoid(s) 577 which control activation of poppets 575A-C. By selectively activating poppets 575A-C, air is distributed through air manifold 576 to and from various ports 531-534. This allows total control over the air spring. The depicted arrangement is simply one example of many possible arrangements. For example, in an alternative arrangement, the air manifold 576 may be perpendicular to the PCB 540, or the PCB 540 may be placed below the air manifold 576, and components may extend through the PCB 540.

FIG. 5C also depicts an ESCM 530 integrated ride height sensor, which, according to the depicted embodiment, includes a mechanical ride height arm 536 attached to an axle 573 and located with one or more bearings 572, with a diametrically magnetized disc magnet 574 which provides positional data to the rotary/linear position IC located on the PCB 540 (See also FIG. 4A). As ride height arm 536 moves, the axle 573 turns accordingly, providing ride height information to the system.

One possible benefit of the depicted embodiment is mounting the ride height sensor arrangement (536, 572, 574 and 578) at the ESCM 530 saves valuable space. According to various embodiments, the ride height arm 536 may be connected to a mechanical linkage (rod) attached to the motorcycle's swing arm. FIGS. 1B and 2 demonstrate such a connection. In various embodiments, the ride height arm 536 may be directly or indirectly connected to the air spring cylinder. The ride height arm 536 provides ride level information and wheel movement information. For example, as the motorcycle's swing arm moves, that movement is transferred to the ride height arm 536, which is used as an input to determine characteristics of the motorcycle.

In various examples, the ride height 536 arm may be coupled to a reference point on the suspension system by a rod. The reference point may be a point of a vehicle swing arm, or a point on a dampening device (air spring cylinder or shock absorber). The suspension reference point should change position responsively to suspension movement, thereby allowing the rod to transfer that movement to the ride height arm 536, moving the arm which is sensed by the ride height sensor.

Where the ESCM 530 is mounted to the motorcycle frame, such as in FIGS. 1B and 2, various embodiments mount the ESCM 530 in a specific orientation which allows for ease of installation while providing free rotation of the ride height sensor arm 536 and movement of the ride height linkage rod for all suspension travel (movement of the rear wheel swing arm).

In various alternative embodiments, the ride height arm may be connected to other portions of the motorcycle. Or, in some embodiments, the ride height arm may be replaced or assisted by an additional sensor, such as an optical ride height sensor, or pressure sensor. For example, the optical sensor could determine the distance between its position, and a point on the swing arm.

The design according to embodiments of the present invention carries additional benefits. The integration of the ride height sensor and ESCM 530 provides a more robust sensor package based on the design of the ESCM 530 housing, sensor arm 536, and sensor axle 573 along with bearing supports 572. Improved overall sensor reliability can also be foreseen by the elimination of wiring and mechanical linkages/mounting supports for a remotely mounted sensor.

Referring back to FIG. 2, according to various embodiments of the present invention, with integrated sensor feedback, the system pneumatically adjusts vehicle ride height (via the air spring cylinder 210) in order to attain optimal suspension travel levels based on dynamic vehicle conditions including vehicle speed, engine speed, throttle position, lean angle, and braking. In conjunction, key suspension system characteristics including dampening (i.e. compression/rebound) are fully adjustable (via a “coil-over” shock absorber 220) which provides a complete suspension system designed to achieve improved rider comfort, vehicle stability, and overall vehicle performance. According to various embodiments, the ESCM 230 can reference the pressure in the air spring cylinder 210 in order to determine load characteristics of the vehicle, in combination with the ride height and suspension movement information transferred via ride height arm 236, and can make the corresponding adjustments.

In various embodiments of the present invention, the ESCM include an integrated accelerometer sensor. The physical location of the accelerometer in the ESCM provides relevant dynamic vehicle data. The integration of this sensor IC on the PCB as part of the ESCM package (mounted above the rear axle as part of the vehicle's sprung weight) allows for more accurate representation of data which can further be utilized for improved suspension adjustments. The multi-axis accelerometer sensor can also help establish vehicle angle and orientation to provide the system with dynamic vehicle feedback for the control strategy of the active suspension system. For example, according to the described embodiment, it would be possible to prevent the system from making suspension adjustments while the vehicle is turning or in a “cornering” orientation.

Referring back to FIGS. 4A and 4B, the accelerometer may be located on the PCB 440 as a sensor 445 or 441A-C(N). The accelerometer may be positioned in close proximity to the rider's seat. As such, various embodiments of the present invention can use accelerometer 445 data to better understand the forces being applied to the rear suspension, such as sprung weight.

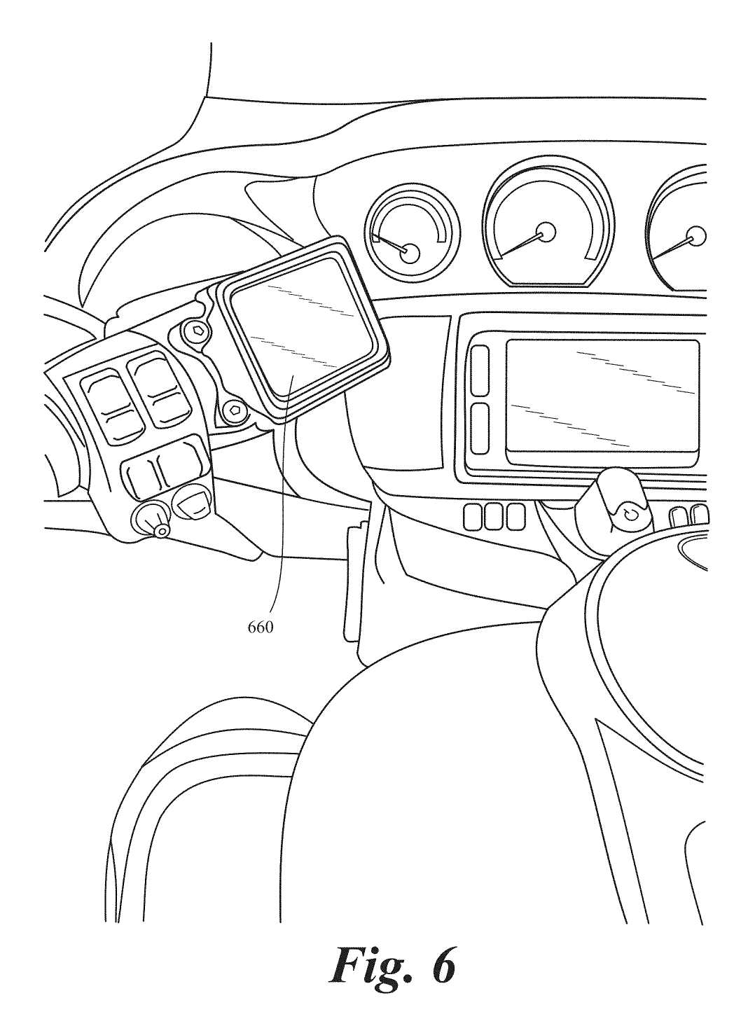

FIG. 6 depicts the user interface display according to an embodiment of the present invention. Various embodiments of the present invention may benefit from a user control screen 660. The control screen may be mounted near the user. For example, User interface control (display screen) may be mounted on the motorcycle hand controls as depicted.

According to various embodiments, the user interface control 660 allows the rider to select, via a touch screen, for example, preferred ride height levels (equating to suspension travel) for various riding modes including city, highway, and stopped positions. The user interface control may be powered and may communicate with the ESCM through an auxiliary interconnect of the vehicle's CAN bus located under the front fairing of the motorcycle (FIG. 3). This allows for a simplified wiring harness which is easier to install and less expensive. In one possible embodiment, the user interface control 660 (display) additionally provides suspension system diagnostic data, vehicle diagnostics (DTC), and other digital gauge options (RPM, vehicle speed, etc.).

In other embodiments, the User may use an existing device, such as a smartphone as the user interface control 660. For example, the smartphone may communicate with the suspension system wirelessly, or alternatively, through an appropriate dongle.

Where the system saves User specific settings, the user may select his or her profile on the interface 660. Or, in alternative embodiments, the user may have a unique identifier on his or her person, a key, or RFID, for example, which may independently signal to the system to load that User's pre-sets.

The system described above is designed to operate in an integrated fashion. For example, a user may select a ride type from the display, the selection is transmitted to the ESCM via the wiring harness. The ESCM responds to the selection by adjusting various parameters, for example, increasing or decreasing ride height and or air pressure in the suspension systems by controlling the air manifold and air compressor.

While the vehicle is in motion, the system may monitor the status of the various components, and respond according to programming. For example, as speed increases, the ride height and spring rate may be adjusted. Suspension settings may change dynamically without input from the user.

Additionally, some models of motorcycles, which are one object of the present invention, are typically very heavy (sprung weight) and if the suspension is not properly adjusted, a single rider's weight often cannot compress the shock absorbers in order to maintain a proper seat level (position relative to rider's height) when stopped. Embodiments of the suspension system according to the present invention provide a solution. For example, the proposed system may detect when the vehicle comes to a stop, via a vehicle speed sensor, for example, an existing sensor which the ESCM communicates with over CAN bus, and may lower the rider's seat level on the motorcycle when stopped, by exhausting air as necessary. This allows riders to “flat-foot” the motorcycle, which is very important for rider safety and overall vehicle stability. Lowering, according to this example, may be achieved by referencing only vehicle speed, or, alternatively, by integrating additional functionality or additional sensors. For example, the User may pull the clutch lever in, or press a button, or perform any other type of additional input so as to prevent the system from lowering the vehicle when it is not desired. Alternatively, the user may select the option to lower, or raise, the vehicle on the user interface.

A method of adjusting the ride height, according to an embodiment of the present invention, may include, for example: (1) referencing an input value, where the input value is speed, (2) referencing an input value, where the input value is ride height, (3) comparing the input values to stored target values, (4) as necessary, adjusting the ride height up or down by activating the air manifold so as to allow exhausting of air, or, alternatively, sending a signal to the air compressor, and a corresponding signal to the air manifold, to send air to the air spring cylinder.

According to a different example, a user may arrive at a destination to pick up a second user. The addition of the second user adds significant weight to the vehicle. When the second user mounts the vehicle, the ride height sensor senses the drop in ride height corresponding to the addition of the second user. This drop in ride height is sent to the ESCM, which triggers the air compressor, and activates the corresponding pathway in the air manifold in order to adjust ride height to an acceptable level.

According to yet another example, a user may be riding along a smooth road before transitioning to a bumpier surface. The suspension system may be able to detect the increased suspension movement, via rapid movement of the ride-height sensor arm and accelerometer data, and adjust dampening accordingly in order to better accommodate the bumpy surface. For example, the system may reduce spring rate and compression dampening in order to provide a more comfortable ride, and in order to ensure that the rear wheel maintains contact with the road surface. The system may also integrate, for example over CAN bus, with the vehicle traction control system, allowing it to respond quickly to traction loss.

An additional embodiment of the invention may utilize two air spring type shock absorbers instead of the proposed combination of coil over shock absorber and air spring cylinder. As previously noted, this embodiment would eliminate the “limp mode” if any pneumatic or electronic components should fail (the suspension would drop). However, this alternative embodiment could maintain the adjustability and characteristics of the ESCM as described above. Further embodiments may use a combination pneumatic and coil over shock.

An additional embodiment of the invention would allow for the ESCM to also control the front suspension characteristics by means of adjusting the air pressure in the front fork. In such an embodiment, ESCM control would allow for effectively changing the spring preload and vehicle height at both ends of the vehicle. According to this embodiment, for example, the PCB (440, FIGS. 4A and 4B) could be configured with an additional pressure transducer with associated changes to housing and manifold (additional solenoid and poppet arrangement) plus pneumatic plumbing to front fork assembly. This embodiment would require an “air piston kit” for the front suspension which is currently available. The ESCM may still rely on a remotely mounting and wired vehicle ride height sensor.

While an embodiment of the invention has been illustrated and described, as noted above, many changes can be made without departing from the spirit and scope of the invention. For example, the present invention has been described with respect to motorcycles, but should not be so limited. The teachings of this invention are also applicable to other types of vehicles where space is at a premium, such as scooters, bicycles, trikes, ATVs, UTVs, and wheel chairs. Accordingly, the scope of the invention is not limited by the disclosure of any embodiment.

The embodiments of the invention in which an exclusive property or privilege is claimed are defined as follows:

1. A suspension control system housed in a single housing, comprising a processor;
a memory module in communication with the processor;
a plurality of sensors electronically coupled to the processor;
a ride height sensor system, comprising;
a ride height arm extending from the housing;
an axle, coupled to the ride height arm at one end; and
a rotary position integrated circuit configured to track movement of the axle
an air management manifold having a plurality of inlets and outlets and wherein the air management manifold includes a plurality of solenoids, each solenoid configured to control movement of air through the air management manifold, and wherein the plurality of solenoids are in electronic communication with the processor; and
a plurality of ports in fluid connection with the inlets and outlets of the air management manifold, disposed on the exterior of the housing.

2. The system of claim 1 further including, where the single housing is positioned on a vehicle near a wheel, and further wherein the ride height arm extending from the housing is coupled to a first end of a rod, the second end of the rod dynamically coupled to a suspension reference point.

3. The system of claim 1 further including where at least two of the plurality of ports in fluid connection with the air management manifold comprise;
a first port, wherein the first port is in fluid communication with an air compressor; and
a second port, wherein the second port is in fluid communication with an air spring.

4. The system of claim 1 wherein at least one of the plurality of sensors comprises an accelerometer.

5. The system of claim 4 where a different at least one of the plurality of sensors comprises a pressure sensor.

6. The system of claim 1 where the suspension control system housed in a single housing further includes a header, the header in electronic communication with the processor and configured to provide bidirectional communication to one or more components located outside of the single housing.

7. The system of claim 6 wherein the one or more components located outside of the single housing includes, at least, a user input panel.

8. The system of claim 7 wherein the user input panel sends a request to the processor, and in response to the request, the plurality of solenoids are selectively controlled corresponding to the requested movement of air through the air management manifold.

9. The system of claim 1 further comprising where:
the single housing is positioned on a motorcycle near a rear wheel, and further wherein the ride height arm extending from the housing is coupled to a first end of a rod, the second end of the rod coupled to a swing arm of the motorcycle;
at least two of the plurality of ports in fluid connection with the air management manifold comprise:
a first port, wherein the first port is coupled to an air compressor at one end, and the suspension control system at the second end; and
a second port, wherein the second port is coupled to an air spring attached to a vehicle at a first end, and the suspension control system at the second end;
and wherein the processor is configured to control activation of the air compressor, and activation of the air management manifold solenoids, in response to a sensed ride height system value that differs from a stored value in the memory module.

10. A vehicle suspension system, comprising:
a first suspension component, the first suspension component comprising a coil-over style shock absorber and spring and supporting a first wheel;
a second suspension component, the second suspension component comprising an air spring and supporting the first wheel;
a suspension control system housed in a single housing, further comprised of:
a processor;
a memory module electronically coupled to the processor;
a plurality of sensors electronically coupled to the processor, wherein at least one of the plurality of sensors is a vehicle ride height sensor;
an air management manifold, wherein the air management manifold includes a plurality of solenoids configured to control air flow through the manifold, and wherein the plurality of solenoids are in electronic communication with the processor;
a plurality of pneumatic inputs and outputs in fluid communication with the air management manifold; and
a ride height arm originating at the suspension control system housing and extending away therefrom.

11. The system of claim 10 wherein at least a second one of the sensors, of the plurality of sensors, comprises an accelerometer.

12. The system of claim 10 wherein the vehicle is a motorcycle, and wherein the first suspension component supports a first side of a rear wheel of the motorcycle and the second suspension component support a second side opposite the first side of the rear wheel of the motorcycle.

13. The system of claim 10 wherein the sensor for determining the ride height of the vehicle is a rotary position sensor, and further wherein the rotary position sensor detects the relative position of an axle, the axle coupled to the ride height arm.

14. The system of claim 10 wherein at least one of the pneumatic inputs in fluid communication with the air management manifold is coupled to a pneumatic pump.

15. The system of claim 14 wherein at least one of the pneumatic outputs in fluid communication with the air management manifold is in fluid communication with the second suspension dampening component, and further wherein the pneumatic pump and the appropriate solenoid are configured accept a request from the processor, and in response, direct pressurize air from the pneumatic pump to the second dampening component.

16. The system of claim 10 further comprising a tie rod, a first end of the tie rod coupled the ride height arm extending from the suspension control system housing, the second end of the ride height arm coupled to a suspension reference point, wherein movement of the suspension reference point is transferred through the tie rod to the ride height arm, and translated to radial motion sensed by the ride height sensor.

17. A method of adjusting motorcycle suspension height, comprising:
Determining a first ride height, wherein the first ride height is determined by sensing the position of an axle located within a suspension control system housing, the axle coupled a ride height arm originating at the suspension control system housing and extending outward, the ride height arm further coupled to a suspension reference point and configured to move with the suspension reference point;
Comparing, at a processor located within the suspension control system housing, the first vehicle ride height to a desired vehicle ride height, and wherein the values do not match, taking the steps of;
transmitting a request to adjust vehicle suspension height, the request originating from the processor, to at least one solenoid at an air management manifold, the air manifold in fluid communication with a compressed air source, a pneumatic suspension dampening component, and the atmosphere, the at least one solenoid and the air management manifold located within the suspension control system housing;
the request corresponding to one of, activating both the compressed air source and a first of the at least solenoids to increase the pressure within the air spring, and activating a second of the at least solenoids to vent excess pressure within the air spring; and
sending a stop signal to the at least one solenoids when the first ride height value and the desired ride height value are the same.
